(19) United States
(12) Patent Application Publication
(10) Pub. No.: US 2015/0128258 A1
(43) Pub. Date: May 7, 2015

(54) AUTHENTICATION MODE REPORTING

(71) Applicant: UTC FIRE & SECURITY CORPORATION, Farmington, CT (US)

(72) Inventor: Yuri Novozhenets, Pittsford, NY (US)

(21) Appl. No.: 14/391,807

(22) PCT Filed: Apr. 10, 2013
(86) PCT No.: PCT/US2013/036051

§ 371 Date: Oct. 10, 2014

Related U.S. Application Data
(60) Provisional application No. 61/622,682, filed on Apr. 11, 2012.

(51) Int. Cl. G06F 21/31

(52) U.S. Cl. CPC G06F 21/31
USPC 726/20

(57) ABSTRACT

Embodiments relate to systems for, and methods of, reporting authentication failures in a security system that includes a token reader and a host. The authentication failure report may include an identification of the type of authentication failure.

### SUMMARY

According to various embodiments, a method of reporting an authentication failure is disclosed. The method may include providing a reader configured to read a token, providing a controller communicatively coupled to the reader by way of a unidirectional protocol and providing a host communicatively coupled to the controller by way of a bidirectional protocol. The method may also include receiving, at the host, a selection of authentication failure types and communicating, from the host to the reader, the selection of authentication failure types. The method may further include receiving, by a reader, data from a token and determining, by the reader, an authentication failure, wherein the authentication is based at least on the data. The method may further include determining, by the reader, that the authentication failure comprises at least one of the authentication failure types and communicating, from the reader to the host, a signal indicating the authentication failure. The method may further include logging, by the host, the authentication failure.

### DESCRIPTION OF DRAWINGS

The accompanying drawings, which are incorporated in and constitute a part of this specification, illustrate embodiments of the present teachings and together with the description, serve to explain the principles of the present teachings. In the figures:

FIG. 1 is a schematic diagram of a system according to various embodiments;

FIG. 2 is a flow chart of a method according to various embodiments; and

FIG. 3 is a schematic depiction of a graphical user interface according to various embodiments.

### DETAILED DESCRIPTION

Various embodiments of the invention include a security system. The security system may include a reader device, which accepts a token such as a smart card and performs authentication. In some embodiments, the system further includes a controller, which receives data from the reader device and is capable of providing access (e.g., unlocking a physical door). In some embodiments, the system further includes a host, which a user may utilize to program the system. In some embodiments, the user can configure the system to report certain types of authentication failures that occur at the reader. The following description discusses these and other embodiments in detail.

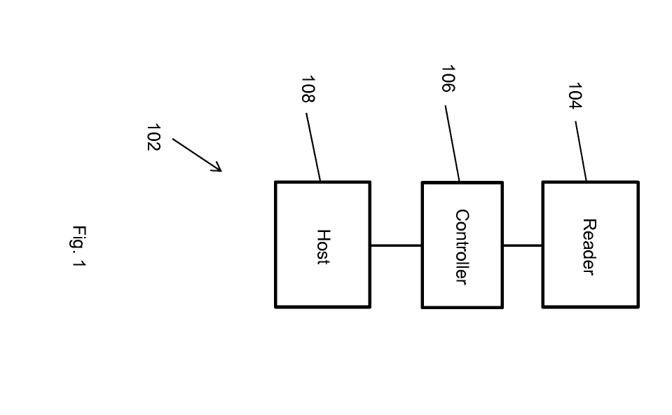

FIG. 1 is a schematic diagram of system 102 according to various embodiments. The system of FIG. 1 includes reader device 104. Reader device 104 is capable of interacting with a token. Example tokens include smart cards, magnetic cards and RFID tokens. Reader device 104 may be capable of receiving data from such tokens and performing authentication, which determines whether the token is authentic. Reader device may also accept additional data, such as biometric data (e.g., retina scans, fingerprints, face geometry, etc.) and/or an entry code (e.g., a personal identification number, or “PIN”). Reader device may utilize public key infrastructure (“PKI”), and may thus be capable of verifying a PKI signature and/or completing a PKI challenge/response, known to those of skill in the art. Reader device 104 may include persistent memory, such as one or both of a hard disk drive and flash memory.

Reader device 104 may be communicatively coupled to controller device 106 by way of a unidirectional protocol. In particular, reader device 104 may be capable of sending messages to controller device 106. Example, non-limiting protocols include the Wiegand protocol and the clock-and-data protocols, which are typically used in security systems.

Controller device 106 may be a Physical Access Control System (“PACS”) device. Controller device 106 may be physically separate from reader device 104. Controller device 106 may capable of determining whether to grant physical access based on token information and possibly additional information. Accordingly, controller device 106 may be operably coupled to a locking/unlocking mechanism of a physical door or similar portal. Further, controller device 106 may include persistent memory, such as one or both of a hard disk drive and flash memory.

Controller device 106 may be communicatively coupled to host device 108 by way of a bi-directional protocol. Such protocol may be, by way of non-limiting example, TCP/IP. Host device may include or be coupled to a display and input device, e.g., a standard computer keyboard and mouse. Host device 108 may include persistent memory, such as one or both of a hard disk drive and flash memory.

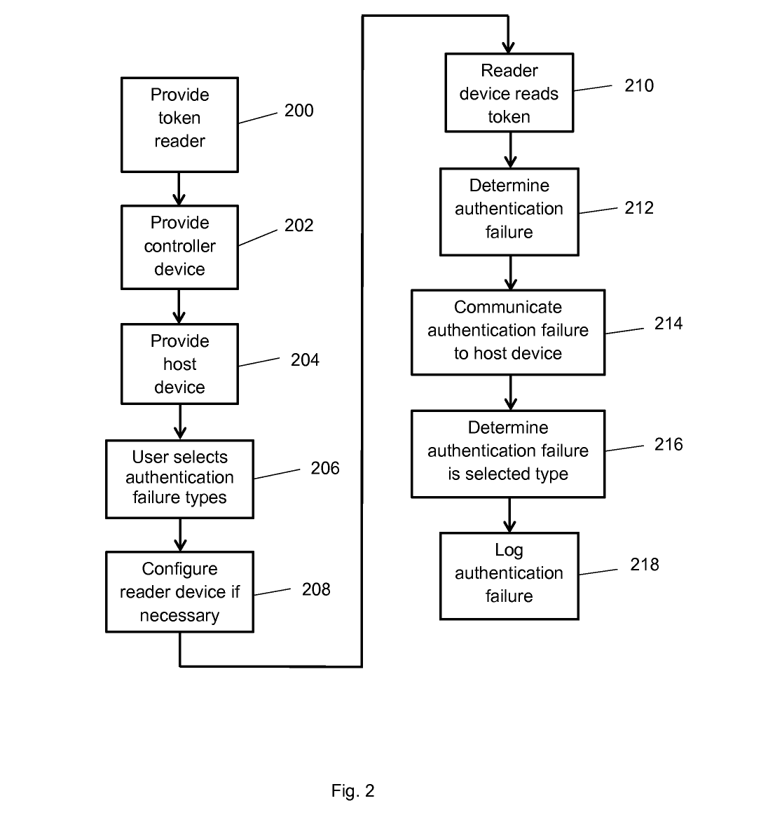

FIG. 2 is a flow chart of a method according to various embodiments. The method of FIG. 2 may be carried out entirely, or in part, by the system discussed above in reference to FIG. 1 for example. Thus, at block 200, a user provides a token reader. The provision may encompass physical installation, activation or physical conveyance (e.g., sales). At block 202, a user provides a controller device (e.g., controller device 106 of FIG. 1). This block may be accomplished in a similar manner as that of the token reader, e.g., physical installation, activation or conveyance. At block 204, a user provides a host device (e.g., host device 108 of FIG. 1). Again, this provision may include physical installation, activation or conveyance. In some embodiments, the host device includes software executing on a general purpose computer. In such embodiments, the provision of block 204 may include software sales or software installation, for example.

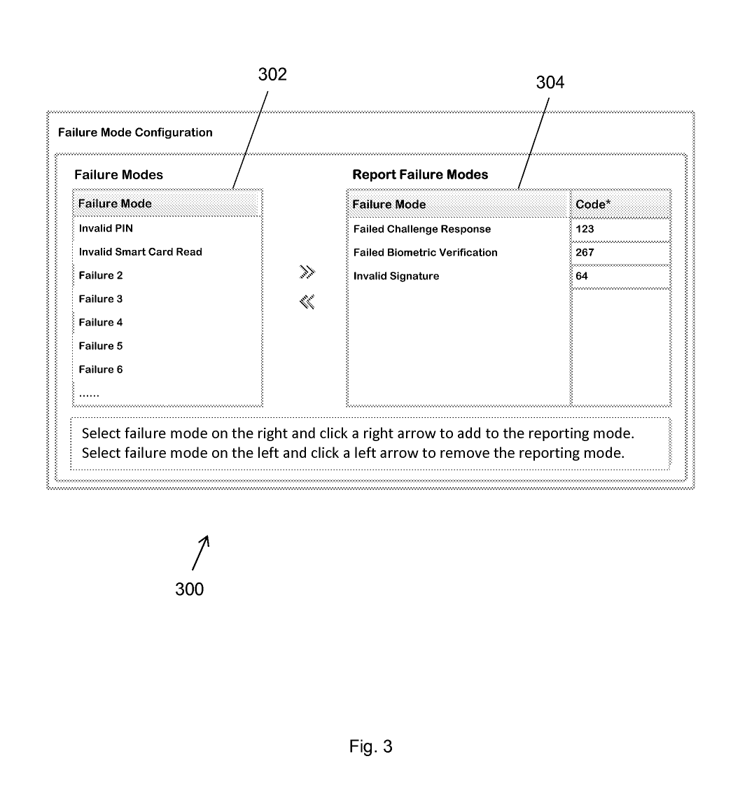

At block 206, a user selects authentication failure types that the user desires to be reported. This action may occur by the user interacting with the host device. Details of how an embodiment may accomplish this step are discussed in detail below in reference to FIG. 3.

At block 208, the reader device is configured, if necessary. The result of the configuration of block 208 is that the reader reports details of authentication failures. Exemplary failure types that may be reported include, by way of non-limiting example: invalid PIN, invalid smart card read, failed challenge response, failed biometric verification and failed signature. In some embodiments, the reader device is configured at the factory, thus obviating an additional configuration step. In some embodiments, the reader device is field configurable, e.g., using an interface together with appropriate software.

At block 210, a user presents the user's token to the token reader device. The manner of presentation may vary according to the type of token. For example, a card with a magnetic stripe may be swiped, or tokens that utilize RFID may be placed in proximity of the reader sufficient to allow the reader to communicate with the token. Any additional data may also be received at this stage. Example such data includes, by way of non-limiting example: PIN and biometric data.

At block 212, the reader device determines an authentication failure. There are many ways that an authentication may fail. For example, the user may be required to enter a PIN at the controller. The controller may determine whether the PIN matches a datum stored on the token (e.g., by matching a cryptographic hash of the PIN with an identical datum stored on the token). If there is a failed match, the authentication may fail. Another type of authentication failure occurs when the reader device fails to correctly read the token. This may occur due to, for example, damage to the token. Yet another type of authentication failure may occur if the user must present biometric identification to the reader in addition to the token. If the biometric information does not match a datum stored on the token, a failure may occur. The matching process may include comparing a hash of biometric information to information stored on the token. Yet another type of authentication failure may occur if a PKI challenge-and-response protocol fails. For example, a smart card may receive data from the controller device, which it is to internally encrypt and return to the controller device for verification. If any part of this protocol fails, the entire authentication of the token may fail. Note that the challenge-and-response direction may be reversed; e.g., the controller may receive data from the card for encryption, return and verification. Yet another way that the authentication may fail includes a detection of an invalid signature. For example, the token may include a datum signed using an asymmetric cryptographic technique, known to those skilled in the art. Should the signature be invalid, the entire authentication may fail.

At block 214, the controller communicates the authentication failure to the host device. Such communication may be by way of the controller. There are several ways that an authentication failure may be reported. In particular, the Wiegand and clock-and-data protocols include specifications for reporting message structures. Embodiments may alter standard reporting records by overlaying, inserting or appending failure mode information (e.g., codes representing particular types of authentication failures). The configured reader device will report events in a specified manner (e.g., relying on specification of event codes, start bits, and number of bits). The host software is matched to the reporting protocol and interprets a particular event code in the incoming access control data stream.

For example, in the event of a successful authentication, the Wiegand protocol may format and prepare a message with a particular number of bits, e.g. 66 bits. Such a message may allot fields (i.e., portions of the message) for, e.g., a facility code, a token identification, an issue code, and a parity. In the event of an authentication failure, such a message may include a field identifying the particular type of failure. Such a field may include, e.g., 10 bits. The authentication failure code field may appear at the end of the message, between other fields in the message, or at the end of the message. The particular structure of the message is known to both the reader device and the host device. In some embodiments, the controller device is also able to parse and interpret the message.

At block 216, a determination is made as to whether the authentication failure type is among those that are to be logged by the host device. This determination may be made by the controller device or the host device.

At block 218, if the particular authentication failure type is to be logged, the host may also log additional information, e.g., facility code, badge ID, issue code, parity, time, date, etc. The logging may include storing in persistent memory a description of the failure, generating a report, sending an email, or another activity that is designed to inform security personnel about a failed authentication.

FIG. 3 is a schematic depiction of a graphical user interface 300 according to various embodiments. Graphical user interface 300 is configured to permit a user to select particular authentication failure types that are to be logged by the host device. Thus, a list of authentication failure types 302 appears on the left side of graphical user interface 300. A user may use “add” and “remove” buttons to select which authentication failure types are to be logged. A list of failure types to log 304 appears on the right side of the graphical user interface.

The foregoing description is illustrative, and variations in configuration and implementation may occur to persons skilled in the art. Other resources described as singular or integrated can in embodiments be plural or distributed, and resources described as multiple or distributed can in embodiments be combined. The scope of the present teachings is accordingly intended to be limited only by the following claims.

What is claimed is:

1. A method of reporting an authentication failure, the method comprising:
providing a reader configured to read a token;
providing a controller communicatively coupled to the reader by way of a unidirectional protocol;
providing a host communicatively coupled to the controller by way of a bidirectional protocol;
receiving, at the host, a selection of authentication failure types;
communicating, from the host to the reader, the selection of authentication failure types;
receiving, by a reader, data from a token;
determining, by the reader, an authentication failure, wherein the authentication is based at least on the data;
determining, by the reader, that the authentication failure comprises at least one of the authentication failure types;
communicating, from the reader to the host, a signal indicating the authentication failure; and
logging, by the host, the authentication failure.

2. The method of claim 1, wherein the unidirectional protocol comprises one of a Wiegand protocol and a clock-and-data protocol.

3. The method of claim 1, wherein the selection of failure types comprises at least one type selected from: invalid PIN, invalid token read, failed challenge response, failed biometric verification and invalid signature.

4. The method of claim 1, wherein the receiving, at the host, a selection of authentication failure types comprises receiving a user's selection via a graphical user interface.

5. The method of claim 1, wherein the signal indicating the authentication failure comprises an identification of the token and an identification of the reader.

6. A system for reporting an authentication failure, the system comprising:
a reader configured to read a token, wherein the reader is configured to store a selection of authentication failure types, receive data from a token, determine an authentication failure based at least on the data and determine that the authentication failure is one of the authentication failure types;
a controller communicatively coupled to the reader by way of a unidirectional protocol; and
a host communicatively coupled to the controller by way of a bidirectional protocol, wherein the host is configured to receive a selection of authentication failure types from a user, receive, from the reader, a signal indicating the authentication failure, and log the authentication failure.

7. The system of claim 6, wherein the unidirectional protocol comprises one of a Wiegand protocol and a clock-and-data protocol.

8. The system of claim 6, wherein the selection of failure types comprises at least one type selected from: invalid PIN, invalid token read, failed challenge response, failed biometric verification and invalid signature.

9. The system of claim 6, wherein the host is further configured to receive the selection of authentication failure types via a graphical user interface.

10. The system of claim 6, wherein the signal indicating the authentication failure comprises an identification of the token and an identification of the reader.
